(19) United States
(12) Patent Application Publication
(10) Pub. No.: US 2012/0089130 A1
(43) Pub. Date: Apr. 12, 2012

(54) AUTOMATIC ELECTRONIC DELIVERY OF MEDICATION FOR VETERINARY AND OTHER USES

(76) Inventors: Robert J. Gyurik, Sanibel, FL (US); Michael VanDierendonck, Scotts Valley, CA (US)

(21) Appl. No.: 13/267,122

(22) Filed: Oct. 6, 2011

Related U.S. Application Data
(60) Provisional application No. 61/390,264, filed on Oct. 6, 2010.

(51) Int. Cl. A61D 7/00

(52) U.S. Cl. 604/891.1

(57) ABSTRACT

A bolus is provided with a housing, an ASIC; PCB; power source; devices for providing a gas-generating explosion, propelling means, antenna; electrodes; weights; medicament containers, and seals. These components provide a controlled delivery of a medicament in the stomach or rumen of an animal.

### CROSS REFERENCE TO RELATED APPLICATION

This application claims the benefit of U.S. Provisional Patent Application No. 61/390,264, filed Oct. 6, 2010, the entirety of which is hereby incorporated by reference into this application.

### I. FIELD OF THE INVENTION

The present invention is directed toward various embodiments of automatic or electronic veterinary drug delivery boluses, and similar devices to control the delivery of medication to a ruminant or other veterinary animal.

### II. BACKGROUND OF THE INVENTION

In veterinary medicine, an automatic bolus has referred to a time-release drug delivery system or device that is lodged in the rumen of cattle, and in goats, sheep and other animals. One object of such a bolus is to deliver drug compounds and medicines to active sites in the body over a given time. The present invention is directed to a type of device, such as a bolus, that delivers a drug or chemical compound in, for example, the rumen, via electronic and mechanical means. The present invention also may release medication to other animals, not exclusively those comprising ruminants.

One form of an automatic veterinary cattle bolus is a weighted, smooth canister that is inserted into an animal such as a cow so as to reside in the reticulum, the first portion of a cow's digestive system for an extended period of time. Most automatic boluses (here forward called simply “boluses”; although “boli” is an accepted form of the plural of bolus, this latter form will not be used here for clarity) in the art work in a passive manner and have very simple functions. For example, a conventional bolus might be used to passively administer a slow release medication. The bolus of the present invention differs from conventional boluses in that it provides a platform for active, built-in electronic devices, which enable the bolus to dispense liquid, granular, or paste medications directly into a cow's rumen. When the bolus of the present invention enters the rumen environment, the device automatically becomes active; it is pre-programmed to release multiple doses of medications at specific time intervals over a period of up to a year. The volume of medication can be a metered amount and is administered directly from the reticulum into the second “stomach”, called the rumen. The bolus of the present invention may be configured at the time of manufacture to deliver different doses and volumes at different time intervals. The device can also be built to deliver multiple independent doses of a medicament. Medicaments that may be delivered by the present invention include, for example, a parasiticide, and would be absorbed or dispensed after delivery throughout the animal for utilization in defeating the subject parasite.

U.S. Pat. No. 4,564,363 (“the '363 Patent”), which is incorporated herein in full by reference, is said to describe a device for effecting the delayed release of an active ingredient comprising a container and, within, a dispersible unit of ingredient having a removable closure and a electrical control circuit connected to a squib, a gas generating device, that caused removal of the closure at a designated time, releasing the active ingredient. The '363 Patent device, however, has a number of deficiencies. It was known to have failed to achieve desired results, and was uneconomic to manufacture and did not achieve desired reliability in practice. One issue, the reproducibility of the heating of the squib wire, a feature of the '363 patent device, led to irreproducible depletion of battery life before all squibs were initiated. Another deficiency that became apparent was that some of the wires were variable enough to lead to initial failure to ignite the squib propellant. Still another deficiency was that, after initial release of the first chamber, impedance was altered in such a way that low level current drain led to premature expenditure of the battery means, this causing at times catastrophic failure to release later programmed doses.

### III. OBJECTS OF THE INVENTION

One object of the present invention is to provide a novel device, including a bolus, for use in treating animals automatically with drugs and other medicaments.

Another object of the present invention is to provide a novel device, including a bolus, for delivering over time a drug or other medicament to an animal.

Another object of the invention is to provide a novel device, including a bolus, comprised of novel arrangements and components that efficiently and effectively deliver drugs and other medicaments to an animal over time.

Another object of the invention is to provide a novel device, including a bolus, that automatically, or remotely, delivers multiple time delayed dosages of the desired drug or medicament to the subject animal without the need for manipulation by the administrator of the device to achieve these dosings.

Still another object of the invention is to provide a novel device, including a bolus, that is inexpensive and economical to manufacture and use. Still another object of the invention, and most importantly, is to provide solutions to the apparent failures encountered in practice for the devices manufactured under the '363 patent.

### IV. SUMMARY OF THE INVENTION

The device of the present invention, as more fully described in the Detailed Description of the Invention, comprises one or more of the following components within, connected to, or used in concert with a housing: an ASIC or similar chip; PCB; battery or other source of electricity or power; squibs or other devices for providing a gas-generating explosion, a propelling means, or similar event; antenna; electrodes; one or more weights; containers, chambers, compartments or tubes, capable of holding drugs or medicaments in the housing, and seals. These are all contained and protected using waterproof or water-resistant technology constructed to protect sensitive components from water- or digestive media. These components function together to provide a controlled and timed delivery of a drug or medicament in the stomach or rumen of an animal. The device of the invention is inserted into the ruminant, conductivity of the ruminant fluids is detected by the electrodes forming a circuit in that environment, the chip senses the environment and is turned on, and clocks then initiate the release of current from the battery. The amount of the current is regulated through transistors on the chip, which current is sufficient to provide the heating of a wire, by spark gap jumping, or frangible wire ignition, of an intimately associated explosive, propellant, or gas-generating composition. Said explosive, propellant or gas generating substance within the device is then initiated, providing an amount of gas below the drug medication in the chamber. The reaction expels the drug from the reticulum eventually into the rumen or stomach. The drug is then transported through the gastrointestinal tract and, if so desired for the medical indication being treated, into the animal's blood system. By way of example, if an anti-parasitic drug is employed, enteroparasites in the GI tract or internal organs are treated with the appropriate medicament, either directly within the GI lumen, or through exposure to medication optionally absorbed via the bloodstream, or both, and, as a result of such treatment, controlled and/or eliminated.

The invention will be more fully described by reference to the following drawings.

### V. BRIEF DESCRIPTION OF THE DRAWINGS

FIG. 1 is a microphotographic example of one of the inventor's custom ASIC, in accordance with the teachings of the present invention.

FIG. 2 is a dose load chart section setting forth details of various boluses versus dose number and volume.

FIG. 3 is a depiction of one embodiment of the veterinary bolus of the present invention and it's components.

FIG. 4 is a high magnification image of a prior art ASIC.

FIG. 5 is a high magnification image of a stand alone ASIC-RFID chip that uses this technology in the device of the present invention.

FIG. 6 shows typical PCBs and how custom ICs may be mounted on them.

FIG. 7 shows that the electronics for a hearing aid are contained in the miniature ‘hybrid’ PCB.

FIG. 8 is the form of three of the squibs for the “off-the-shelf bolus of the present invention.

### VI. DETAILED DESCRIPTION OF THE INVENTION

### A. Product Features

One embodiment of the present invention is to provide an automatic, electronic administration of independent doses of any combination of anthelmintics and/or medicaments or nutrients to a subject animal. Depending on the chosen design contemplated within the present invention, the device will be able to dispense multiple doses to the subject. The only limitation is the volume available within the bolus vs. the volume of the doses desired. The present invention utilizes enough battery capacity to administer multiple doses. Not all doses need to be identical in formulation and volume. Multiple formulations can be completely isolated within the bolus and released at different times to avoid conflicts of multiple formulations reacting with each other.

The device of the present invention provides up to 100% displacement of formulation dose upon scheduled release, as opposed to what is called simply slow, delayed, or controlled continuous release in the art of drug delivery. The bolus of the invention utilizes squibs or the equivalent displacement means herein described to completely displace all contents from within a single dose cylinder to, for example, the digestive system of a cow. It is not a conventional slow release method; however, this does not preclude the instantaneous release of a formulation that is designed to subsequently slowly release in the animal. Such slow, or delayed release formulations are generally known in the art of pharmaceutics. In any case, a plunger or stopper holding the contents of the bolus in place, and insuring watertight isolation of such contents from the digestive fluids in the animal, will thus be displaced and the entire contents removed from the dose cylinder at once.

In one embodiment of the invention, a preprogrammed release interval is set at a printed circuit board (“PCB”) level in its manufacture, or at the wafer level in silicon chip fabrication. This enables the customer or user to be provided with multiple configurations of boluses. For example, one product line may deliver three doses of formulation, but have various different delivery times. One product may have 30 day, 60 and 90 day dispenses, while another product might dispense at 1 day, 45 day and 90 day intervals. In addition, one basic platform can be produced that would take minor manufacturing changes to adapt the platform to different time configurations. There are at least two ways to accomplish the different time configurations: One is to have multiple jumper wire options on the PCB that would enable different timing features of the device. The jumper wires would be configured during the operation of PCB assembly to enable the desired timing interval. The advantage would be that a single PCB assembly would work for each different timing option. This technique is used in other types of products, and is well-known in the art of digital microprocessing PCB design.

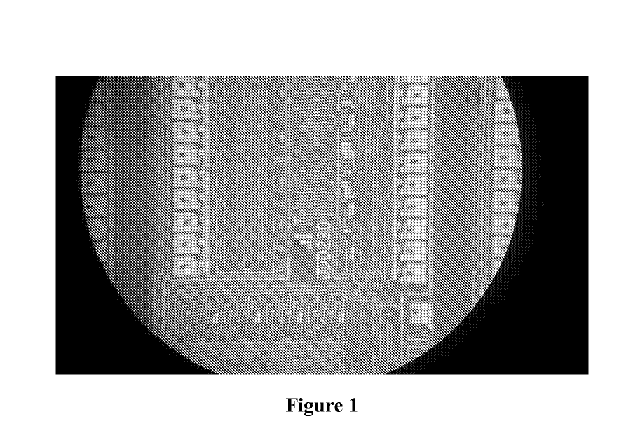

Another method of program timing is to change the time intervals in the silicon itself. There two ways to accomplish this, and both are used in the industry. The first is to generate multiple metal masks in the manufacturing of the semiconductors themselves. The other option at the semiconductor level is to program the selected timing schedule during wafer sort. It is within the scope of the invention to use Application Specific Integrated Circuits (“ASICS”) having metal fuse links that are electrically opened to configure the parts to the final product. In addition, wafer sort is a process of performing the electrical testing of every silicon ASIC prior to PCB assembly. FIG. 1, shows a microphotographic example of one of the inventor's custom ASIC. As shown, banks of fuses are shown on both sides of the ASIC. One can see that some are darkened or “blown” to provide a specific configuration. In this case, the fuses were blown to provide a binary code, so that every individual part has a unique code. This technique can be used if the user desires multiple timing options to support multiple variations of boluses within a single platform.

### B. Dimensions

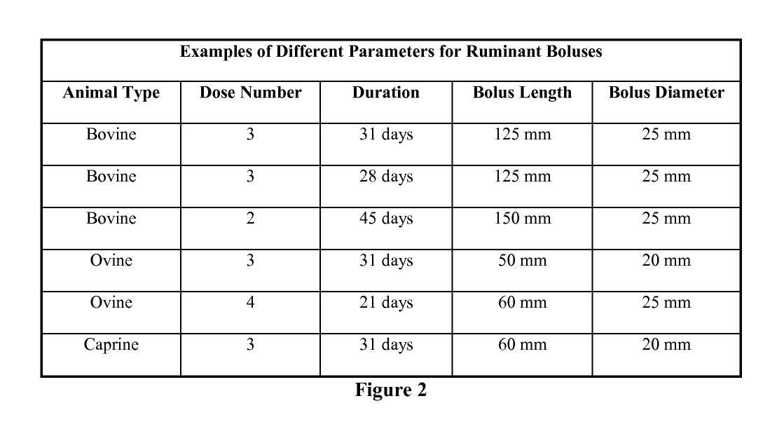

The size and dimensions of the device of the present invention are various and include those chosen and made by one of skill in the art for desired applications. For example, a bolus of the present invention can be approximately 25 mm diameter X 100 mm-175 mm long, depending on dose volumes and quantities of medicaments. The dimensions may vary depending on the applications the skilled worker or end user pursues. One embodiment of the bolus of the present invention would have a length in the range of 100 mm to 175 mm. These dimensions are appropriate for bovine ruminants. For ovine or caprine ruminant animals, e.g. sheep and goats, dimensions may be much smaller, typically 20 mm×40-70 mm. FIG. 2, is a dose load chart section setting forth details of various boluses versus dose number and volume. These are meant to be exemplary and other combinations are anticipated in the current invention.

For the exemplary FIG. 2, the amount (payload) of each individual dose is determined by the nature of the medicament. For a medicament with a desired payload of 10 mg/Kg of active, for example, would require 5 grams of active ingredient for a 500 Kg animal. As animals are typically dosed in a group setting with animals of approximately similar ages, each animal would be of approximately the same size, statistically necessitating only one uniform dosage for the group. Although animals are increasing in weight during the entire several months of the dosing regimen, it has been found in practice that dosages do not have to be extrapolated upward with each successive dose to accommodate the small percentage weight gain during this period to achieve similar blood levels of active ingredient, because of natural variation in delivery, although this increase in each successive chamber could be envisaged as an alternative, if desired. In practice, statistical variation among animals swamps the small incremental increases in successive dosages.

### Dose Load Chart

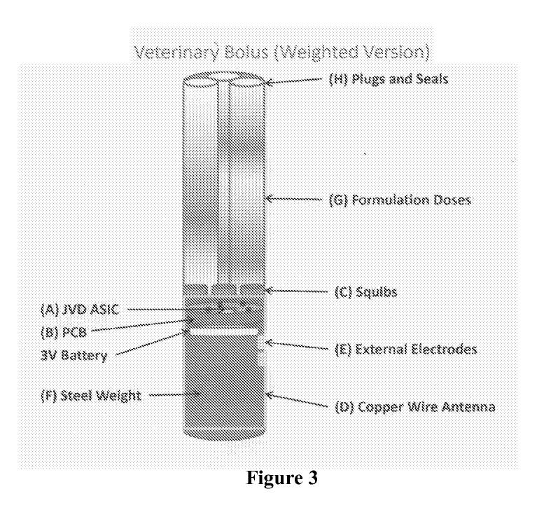

The following chart reflects dose loads for different variations of the device of the invention. The data reflect a bolus with a width of 25 mm. The variations include bolus lengths ranging from approximately 100 mm-175 mm. The chart also provides data for the change in available dose volume depending on the overall specific gravity of the bolus. For a three chambered (trilobal design as shown in FIG. 3) device, each chamber has the dimensions of approximately 1 cm diameter by 7 cm in length for a 2.5 cm, 12.5 cm bolus. The dosage capacity is then approximately 5 cc per chamber. The dimensions of each dosage chamber is further determined by the number of chambers involved. In summary then, the total dosage capacity per dose may be limited by the volume of each dosing chamber which is constrained by the number of chambers and the total dimensions of the bolus. The desired configuration will be apparent by those skilled in the art of per os dosing of ruminant animals for the given intended medication.

The total bolus specific gravity (sp.g.) range for the design in this chart ranges from 2.1 to 2.7 grams/cubic centimeter (g/cc). As the specific gravity of the bolus increases, the total volume of dose formulation will be limited since the volume of the bolus is occupied by the weight means. It is generally prudent to optimize these parameters for increasing sp.g.; sp.g. does not have an upper maximum boundary, as long as the minimum level of around 2 g/cc is maintained. The table below shows how much formulation volume would be available for each dose for a bolus with two to six doses. The majority of the table reflects data for a conventional version of the bolus—the “weighted” version. The bottom of the chart shows a table for a “winged” version, an alternative embodiment of the claimed invention.

Estimated Dose Volumes for Veterinary Bolus

| | | | Total | | | | | |
|---|---|---|---|---|---|---|---|---|
| Bolus | Bolus | Bolus | Available | | | | | |
| Width | Length | Specific | Dose | Independent Per Dose Volume(cm²) Bolus Dose Qty. | | | | |
| (mm) | (cm) | Gravity | Volume(cm²) | 2 doses | 3 doses | 4 doses | 5 doses | 6 doses |

The data below reflects the estimated dose volumes for a “weighted” version of the Veterinary Bolus

| | | | | | | | | |
|---|---|---|---|---|---|---|---|---|
| 25 | 17.78 | 2.7 | 49.7 | 24.5 | 15.5 | 12.4 | 9.9 | 8.2 |
| 25 | 15.24 | 2.7 | 48.4 | 20.3 | 13.8 | 10.3 | 8.3 | 5.5 |
| 25 | 12.7 | 2.7 | 32.9 | 35.5 | 12.5 | 8.2 | 6.5 | 5.5 |
| 25 | 20.36 | 3.3 | 34.5 | 32.3 | 8.2 | 5.1 | 6.3 | 4.1 |
| 25 | | | | | | | | |
| 25 | 37.78 | 2.5 | 52.0 | 26.0 | 17.3 | 13.0 | 10.8 | 5.7 |
| 25 | 35.74 | 3.5 | 43.4 | 34.7 | 14.5 | 10.8 | 8.7 | 7.3 |
| 25 | 12.7 | 2.5 | 34.6 | 37.3 | 11.5 | 2.6 | 6.3 | 5.8 |
| 25 | 10.18 | 2.5 | 25.3 | 32.5 | 8.4 | 6.5 | 5.2 | 4.3 |
| 25 | | | | | | | | |
| 25 | 17.78 | 3.3 | 54.2 | 37.2 | 18.1 | 13.5 | 10.8 | 9.1 |
| 25 | 18.24 | 2.3 | 45.3 | 22.7 | 15.3 | 11.3 | 9.1 | 2.8 |
| 25 | 12.7 | 2.3 | 36.2 | 18.3 | 12.1 | 3.3 | 7.2 | 5.9 |
| 25 | 35.30 | 2.3 | 27.2 | 13.6 | 5.1 | 6.8 | 5.4 | 4.5 |
| 25 | | | | | | | | |
| 25 | 17.78 | 2.2 | 96.7 | 28.3 | 18.8 | 14.2 | 11.3 | 9.8 |
| 25 | 15.24 | 2.2 | 47.3 | 23.3 | 15.5 | 11.8 | 9.3 | 7.5 |
| 25 | 32.7 | 3.5 | 37.9 | 18.0 | 12.5 | 9.5 | 7.5 | 6.3 |
| 25 | 10.36 | 2.1 | 39.5 | 34.3 | 9.5 | 7.1 | 5.7 | 4.8 |

The data below reflects the estimated dose volumes for a “winged” version of the Veterinary Bolus

| | | | | | | | | |
|---|---|---|---|---|---|---|---|---|
| 2.54 | 17.78 | 0.3 | 79.9 | 40.0 | 26.6 | 20.0 | 15.0 | 13.3 |
| 2.54 | 15.24 | 0.3 | 67.3 | 33.6 | 22.4 | 18.8 | 13.5 | 11.2 |
| 2.54 | 12.7 | 0.3 | 94.5 | 27.3 | 18.2 | 13.5 | 10.5 | 9.1 |
| 2.54 | 10.16 | 0.3 | 43.8 | 20.9 | 19.9 | 10.5 | 8.4 | 7.6 |

Design Considerations and Variables in this Table Include
1) Overall Bolus Length from 10.16 cm-17.78 cm
2) Specific Gravity Ranges from 2.1-2.7
3) Quantity of Doses Per Bolus

### C. Physical Description of the Product

FIG. 3, is a depiction of one embodiment of the veterinary bolus of the present invention and it's components. The plugs or seals may be simple rubber or composite stoppers as exemplified by elastomer stoppers used in hypodermic syringes, as is well-known in that art. The formulation doses and types are well known to those skilled in pharmaceutics or pharmacy, but granulations that resist caking due to moisture are preferred embodiments, since these are expelled most readily. A disintegrating pellet or granule is anticipated to be most effective due to rapid availability once the chamber contents are expelled. The squibs, or squib equivalents are defined later. The steel weight means is provided, preferably by steel shot or pellets. The copper wire is optionally included if an identification means is desired, whereby an animal may be monitored by, for example, radiofrequency interrogation means. Other identification means by magnetic or other types of identification systems known in this art are not excluded and are incorporated herein by reference. The external electrodes are sensors that sense the environment, and are controlled by the integrated circuit means. They are preferable made of conductive material such as conductive rubber or such material as known in the field of electrically conductive materials.

As shown in FIG. 3, the ASIC (location A) of the present invention is mounted on a circular printed circuit board (PCB) containing a few discrete components (Location B). The PCB makes a connection to three squibs (three squibs are used if a three dose bolus is to be built.) (location C). The PCB may be optionally connected to a small gauge copper wire antenna (location D). The PCB is also connected to external electrodes (location E). The electronic components are powered by a 3V coin cell battery. The bolus of the invention may also utilize additional 3V coin cell batteries, or other sources of power, to prolong the life of the RFID beyond the dispensing period. In addition, the form of battery or other power source may change from the coin cell type to others as would be utilized by those of skill in the art. One end of the bolus contains a steel weight (location F). The opposite end of the bolus contain the three independent doses of formulation (location G). Plugs or seals for each dose are located at the end of each dose tube (location H).

### D. Description of the Components of the Bolus

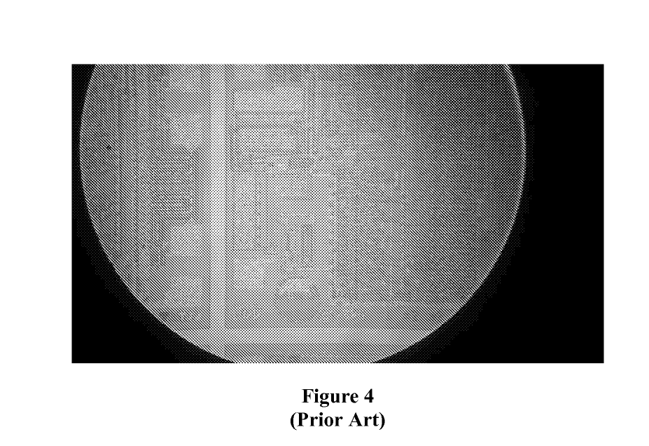

The ASIC is a key component of the veterinary bolus system of the instant invention. The ASIC acts as the “brains” of the device. The conventional ASIC developed for a prior art bolus, FIG. 4, contained an automatic rumen detection system, timing features, and power delivery system to activate the squibs. This ASIC was used for field trials and was considered to be a production-ready part. FIG. 4 shows a high magnification image of the prior ASIC.

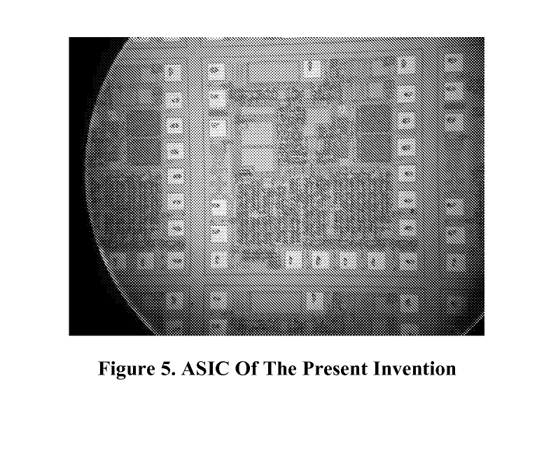

This prior art ASIC was ineffective because of problems with reliability of the design. Dosages were not dispensed reliably, leading to catastrophic failures that necessitated termination of the project, so the present invention, utilizing a novel combination of components, is meant to correct those deficiencies and obviate such failures in practice. Utilizing modern advances in technology, the new ASIC of the present invention has more features in a smaller size, a lower cost per unit, and is intended to use less power with perhaps smaller or fewer batteries, thus preventing such catastrophic current loss that prevented release of medicaments from all intended doses as was apparent in the prior art design. An impedance leak in the prior art also contributed to failure due to premature battery drain, and this is obviated and corrected in the current invention. One additional significant new feature optionally incorporated in the new ASIC is Radio Frequency Identification (“RFID”) technology, which may be used in one embodiment of the present invention. FIG. 5, is a high magnification image of a stand alone RFID chip that uses this technology in the device of the present invention. The integrated new part will be produced using cutting edge silicon processing technology that offers all the advantages of increased performance at a reduced cost.

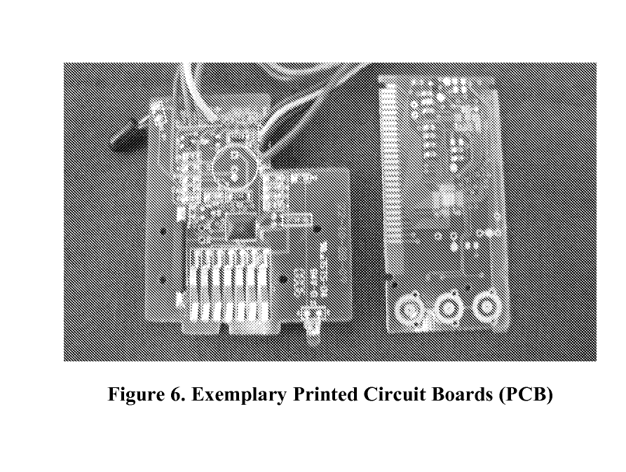

The printed circuit board (“PCB”) of the present invention holds the majority of the electronic components of the bolus. Two examples of PCBs using ASICs within the scope of the invention are set forth in FIG. 6.

FIG. 6 shows typical PCBs and how custom ICs may be mounted on them. The PCB for the bolus of the present invention product may contain the new ASIC, a one O-bit microprocessor for digital data storage, and a few discrete components. The PCB may also have some external components, for example, transistors, capacitors, and a crystal oscillator used as a clock for accurate timing of dispenses. The PCB for the present invention may be circular in shape and slightly less than 25 mm in diameter. The PCB can be optimized in shape and design to minimize the space required for placement within the veterinary bolus. Very small PCBs can be produced. To optimize sealing for watertightness and to accommodate even spacing of squibs for an even release of each chamber, it is advantageous to have the printed circuit board situated perpendicular to the bolus axis and be of circular design. However, an optional embodiment would have the squib or alternate release means on a separate circuit board from the integrated circuit connected by typical means to complete the requisite circuit on the squib board.

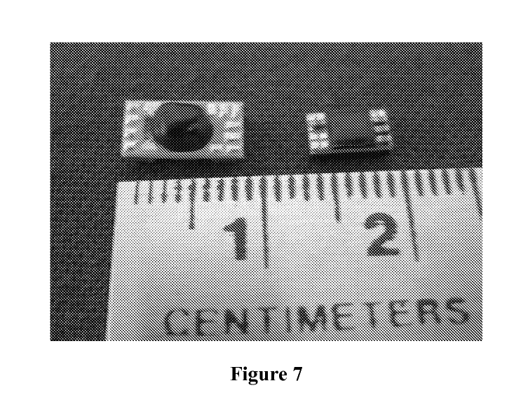

For the purpose of depicting the actual size of a PCB with the ASIC of the present invention, FIG. 7, shows that the electronics for a hearing aid are contained in the miniature ‘hybrid’ PCB. The smaller one shown is only 3 mm by 6 mm in size.

The squibs are the source of the rapid gas expansion used to displace the contents of each dose from within the bolus.

The prior art bolus developed was relatively expensive, primarily due to the expense of the squibs. The squibs were custom made by a military contractor and the cost of each squib was about $2. One squib was required for each dose; therefore the squibs were the driving cost of the bolus. The gas generated by each squib expels the contents of the dosage in the chamber. One squib is required for each chamber. The current is provided from the battery means, regulated in amount and duration by the integrated circuit at the desired timing intervals. The present inventors have utilized a lower cost alternative and version, which is in the range of 10 to 12 cents per squib.

### “Off-the-Shelf” Squib Means

One such squib will be called here the “Remington” squib, the patents to which are believed to be assigned to Remington Arms, Ltd. This squib is small and utilizes a conductive explosive through which the current passes, igniting the explosive. It can be more easily situated on a PCB than the prior art in the '363 patent, requiring no solder points for affixation and conductivity, although conventional soldering may be utilized if desired.

### Custom Squib Means-“Gap-Jumping” Squib

An alternative squib design within the scope of the invention is incorporated herein as an alternative gas generating means. This entails utilizing either a small gap over which the voltage, controlled in extent and duration by the circuit logic, is caused to “jump” a predesigned gap, generating a small spark. This spark provides enough energy to ignite an explosive, either contained in a small can to ensure protection from any deteriorating effects of the environment, or deposited on the plane of the circuit board above the “spark gap” and protected with a lacquer or suitable sealer to protect the explosive, which protective means are known to practitioners in this protective art.

### Custom Squib Means-“Frangible” Squib

Yet another alternative squib design within the scope of the invention is incorporated herein as an alternative gas generating means. This entails utilizing, as an ignition source for the explosive, gas-generating means, a decrepitating frangible wire that produces hot sparks or chaff. This wire, when current is applied decrepitates, producing sparks or hot fragments as the wire burns, thus igniting the explosive and ultimately expelling the dosage. A magnesium alloy wire or ribbon may be used for this purpose, although other alloys, known in the art of metallurgy, may be employed. Again, suitable current and voltage is provided by the integrated circuit by regulating the requisite battery output.

### Squib Proxy Means

One preferred embodiment of the present invention provides a means of gas generation without using the explosive as a pre-packaged construction in a conventional squib device or enclosure, as is the case in the '363 patent or with the Remington squib. This entails, for example, but not limited to this example, placing a spot of conductive explosive on a circuit bridge gap through which conductive explosive the current would pass, igniting the gas-generating explosive. Again, the explosive would be protected with a suitable lacquer. A hot chaff or sparking frangible wire or ribbon element as in the frangible squib embodiment described above, could also be used instead of a formed squib, igniting a conventional, non-conducting explosive.

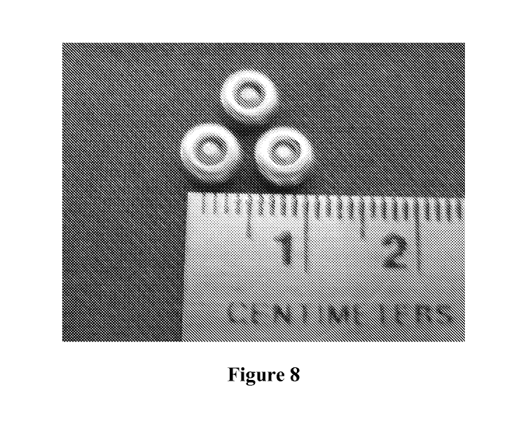

The cost reduction and ease of assembly for the overall system for these new squib or squib proxy designs is dramatic. There may be other methods for the displacement of formulation from within the bolus; however, the above-anticipated means are the most economical approach from both a material and manufacturing standpoint. Manufacturability is key to the utility of the present invention. FIG. 8, shows the form of three of the squibs for the “off-the-shelf bolus of the present invention. As is shown in FIG. 8, the squibs are 5.4 mm in diameter and 3.1 mm thick.

### Optional Embodiment

### RFID Means

In one optional embodiment of the present invention, a copper wire antenna is connected to the ASIC via the PCB. This antenna is used for transmission and receiving of RFID data to and from the new bolus. The copper wire is wound several times around the inside perimeter of the bolus to form an optimized antenna. The diameter of this copper wire is approximately 0.2 mm.

### External Conductive Electrodes

The external electrodes used for automatically enabling the device are inexpensive conductive materials, used to detect the fluid environment of a cow's rumen. The composition and location of the electrodes for this device will be similar to that used in conventional bolus designs. Incorporating this particular embodiment from the '363 Patent by reference, a conductive polymer is employed. The composition is a natural polymer like rubber, or a synthetic polymer, any of which contains additionally, as a necessary component of their composition, a conductive material such as elemental carbon and/or another metallic element, with sufficient conductivity to maintain an electric circuit. Another unforeseen important drawback of the '363 Patent that led to failures in practice was that, under certain circumstances, the conductive rubber electrode failed to be wetted in an aqueous environment. When this happened, some devices failed to turn themselves on leading to catastrophic failures. A remedy is to use an amphiphilic metal, like silver, to allow intimate contact with the electrode to occur. This can be provided by painting the conductive rubber electrode with silver paint, or incorporating a small amount of silver nanoparticles in the rubber. This improvement is deemed to be a necessary remedy to obviate failure such as was experienced with some of the devices of the '363 Patent. Wettability of the external electrodes is a key design feature that will be tested thoroughly to obviate malfunction for this reason in the current invention.

### Weight Means

The actual composition of this material of the weight may vary for the device of the present invention. The purpose of the weight component is to ensure rumen retention. While, some work within the scope of the skilled worker may have to be done to verify the most cost effective, safe material (likely steel or iron), and the most cost effective form (shot, pellets, or slugs), for a bolus specific gravity of 2.75 the steel shot would consume approximately 35% of the total volume of the bolus.

### Dosing Chamber Seals

The present invention incorporates the use of plugs or seals to retain the medicaments in the bolus and ensure their isolation from the rumen environment until the release of the medication is assured at the designated time. These are preferably situated at the end of each dose chamber tube to contain and protect the formulation prior to displacement. At the preprogrammed time for administration of the medicament into a cow's stomach, one of the squibs will be fired by the ASIC. The pressure provided by the gas release from the explosive behind the formulation pushes on the formulation and forces the seal to dislodge, thus displacing the entirety of formulation, as a bolus, or immediate dose, from the first stomach, the reticulum, into the cow's second stomach, the rumen, where mixing with the contents and subsequent absorption occurs.

### Functioning of the Invention

The device of the present invention is provided to the ruminant animal manually through the use of a simple applicator, well known in the art of veterinary medicine, which dispenses devices by means of a simple release plunger. These are known as applicators, or plunger release applicators. Because of the appropriate weighting, the device lodges in the first stomach, the reticulum. This area contains fluid with sufficient conductivity, often around 20,000 to 40,000 reciprocal Ohms, to be sensed by a conductive circuit connected with the external conductive rubber electrodes. As explained in the '363 Patent, the logic implicit in the integrated circuit senses that environment, and turns itself on. This initiates a series of events that turns the electronic clocks on the chip on, and turns the external electrode sensing means off. After the requisite interval, the clocks then initiate the release of current from the battery. The amount of the current is regulated through transistors on the chip which are sufficient to provide the heating of the wire, spark gap jumping, or frangible wire ignition as explained above. Alternately, components on the PCB such as Field-Effect Transistors may also provide current control for the ignition. The explosive is then initiated, providing several cubic centimeters of gas below the medication in the chamber. This expels the drug in its entirety into the reticulo-rumen. Subsequently, the drug is transported through the GI tract and eventually into the animal's blood system. If an anti-parasitic drug is employed, enteroparasites in the GI tract or in the internal organs are treated with the appropriate medicament and eliminated.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

1. A device comprising:
a housing;
components within said housing comprising,
an ASIC or similar chip;
a PCB;
a battery or other device for providing a source of power;
a squib or other device for providing an explosive-type or propelling event;
electrodes;
one or more containers capable of holding a drug or medicament.

2. A method of delivering a drug or medicament to an animal using the device of claim 1.
